(19) United States
(12) Patent Application Publication
(10) Pub. No.: US 2006/0165950 A1
(43) Pub. Date: Jul. 27, 2006

(54) Recyclable rubber surface covering

(76) Inventor: Arthur B. Dodge III, Lancaster, PA (US)

Correspondence Address: BARLEY SNYDER, LLC, 1000 WESTLAKES DRIVE, SUITE 275, BERWYN, PA, 19312, US

(21) Appl. No.: 11/336,116

(22) Filed: Jan. 20, 2006

Related U.S. Application Data
(60) Provisional application No. 60/645,834, filed on Jan. 21, 2005.

(51) Int. Cl. B05D 1/16; B29C 67/24; B05D 1/14; B29C 67/02

(52) U.S. Cl. 428/90; 427/180; 264/109; 264/118; 264/123

(57) ABSTRACT

A surface covering is provided, comprising a substrate with a flocking layer adhered to the substrate by an adhesive. The substrate is formed at least partially from granulated recycled rubber and a binding agent. In an exemplary embodiment, a design is applied to the flocking layer.

### FIELD OF THE INVENTION

The invention relates to a surface covering and more particularly to a decorative surface covering that is recyclable.

### BACKGROUND

Floor coverings are widely used to provide aesthetic appeal and also to provide acoustic properties suitable for the environment in which they are used.

Over 5 billion square feet of carpet is installed in North America each year, and presently, roughly an equivalent amount requires disposal. Typically, this discarded carpet is placed in landfills. In 2002, members of the carpet industry and government representatives at the federal, state and local levels sanctioned the Carpet America Recovery Effort (CARE), which has a goal of reducing by forty percent (40%), the amount of carpet that is disposed of in the nation's landfills by the year 2012. To accomplish this goal, ways are being sought to encourage recycling used carpet.

Presently, less than one percent (1%) of discarded carpet is recycled each year. This low rate of recycling is due, in part, to the fact that traditional carpet products consist of dissimilar materials. For example, nylon fibers may be knitted or woven into a matrix with a urethane or latex backing. It is generally undesirable in making new products from recycled material to commingle materials such as nylon from carpet fibers with urethane or latex from carpet backings. Hence, in addition to logistical and contamination concerns, a fundamental problem with carpet recycling is that the fibers and backing cannot be commingled. For this reason, it is presently impossible to produce new carpet from old carpet.

Poor acoustic properties are extremely undesirable in residential and office structures, as the occupants of one floor do not want to be disturbed by the occupants of the floor above. Sound that is transmitted through the building structure (impact sound) can be particularly troublesome in multiple-floor buildings. In fact, standards have been developed and modified to insure that sound is not transmitted. The ASTM Impact Sound related tests are E492-90 and E989-89. Where noise codes exist, generally IIC50 is specified.

Woven and knitted carpets are well suited to absorbing impact sound and are widely used as floor coverings in office and residential environments. These carpets, however, have several disadvantages. Disposal of worn or soiled carpets can be problematic, both from an environmental and from a cost perspective. Also, providing a wide variety of patterns and particularly custom patterns can be costly.

One alternative to woven and knitted carpets is a flocked floor covering. Existing flocked floor coverings comprise nylon fibers electrostatically flocked onto a poly vinyl chloride (PVC) backing. A glass fiber layer is added between the PVC backing and the flocking to provide dimensional stability. The flocked floor covering is screen printed to provide a wide range of patterns and colors. This floor covering suffers from several disadvantages. PVC is not recyclable and is a hazardous material, causing handling and disposal problems. Also, the need for a glass fiber layer increases manufacturing complexity and cost and adds to the products non-recyclability.

Accordingly, a need exists for a floor covering which provides desirable functionality, acoustic properties and pattern versatility and which can be recycled into new surface covering and/or other recycled materials.

### SUMMARY

A surface covering is provided, comprising a substrate with a flocking layer adhered to the substrate by an adhesive. The substrate is formed from granulated rubber and a binding agent, with at least a portion of the granulated rubber being recycled from used surface covering. In a preferred exemplary embodiment, a design is applied to the flocking layer. A method for forming the surface covering is also provided, which includes grinding worn or soiled surface covering, and forming the substrate using granulated recycled floor covering mixed with a binder.

The surface covering, which may be used on floors, walls, and vehicle interiors, provides good acoustic properties, durability, is recyclable, and uses recycled rubber.

### BRIEF DESCRIPTION OF THE DRAWINGS

Exemplary embodiments of the invention will be described in detail with reference to the accompanying drawing figures, of which:

FIG. 1 is a sectional view of a surface covering according to an exemplary embodiment of the invention; and

FIG. 2 shows a manufacturing sequence for forming a surface covering using recycled product according to an exemplary embodiment of the invention.

### DETAILED DESCRIPTION OF THE EMBODIMENT(S)

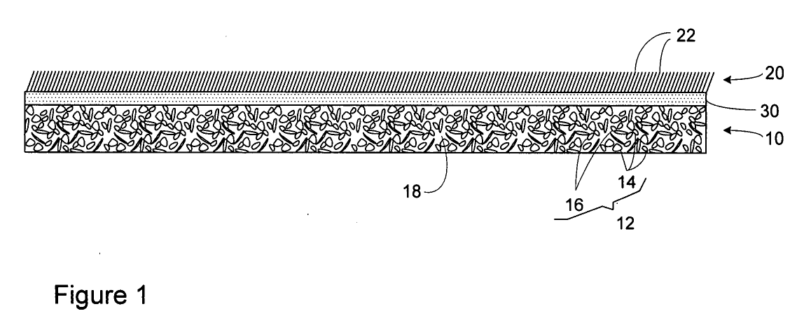

As shown in FIG. 1, a surface covering 1 according to an exemplary embodiment of the present invention comprises a substrate 10 formed from granulated rubber 12 and a binder 18 with a flocking layer 20 adhered to the substrate by an adhesive 30.

In an exemplary embodiment, the granulated rubber 12 is a combination of granulated recycled rubber from recycled surface covering 14 and granulated recycled rubber from other sources 16, such as tires, for example. In an exemplary preferred embodiment, the granulated rubber 12 comprises Styrene Butadiene Rubber (SBR). Alternatively, the granulated rubber 12 may comprise other forms, such Ethylene Propylene Diomene Monomer (EDPM) or natural rubber. Virgin rubber in various forms may also be added in granulated form, but is not required to practice the invention. In an exemplary preferred embodiment, the substrate 10 comprises at least 10 wt-% of granulated recycled rubber from recycled surface covering 14. The granulated rubber 12 may vary in particle size according to the desired porosity and resulting impact sound absorption properties of the finished substrate 10. In an exemplary embodiment, the grain size may vary between about 0.5 mm and 3.0 mm.

The granulated rubber 12 is combined with a binder 18, and compressed at ambient temperature to form a billet of recycled rubber (not shown). The substrate 10 is formed from the billet. In an exemplary embodiment, the billet is cylindrical in shape, and is shaved by rotating the cylindrical billet while introducing a blade against the billet to form a continuous substrate 10 that is flexible enough to be rolled and provides desirable void distribution. The substrate 10 has good dimensional stability, and provides good impact sound properties. In an exemplary embodiment, the binder 18 is polyurethane, which is added to the granulated rubber 12 as a foam and is set or cured by applying pressure.

An adhesive layer 30 is applied to a front face of the substrate 10, and a flocking layer 20 is adhered to the substrate 10 by the adhesive layer 30. The adhesive may be any adhesive suitable for adhering fibers of the flocking layer 20 to a rubber substrate. For example, polymeric adhesives, such as urethane adhesives, latex adhesives, and particularly acrylic adhesives, are well suited for use in the present invention. In an exemplary embodiment, the flocking layer comprises fibers 22, which are made using a polymeric material, such as nylon. The quantity, length, and denier of the fibers may vary depending upon the application, and are selected to provide the desired look and feel of the covering. The fibers 22 may be applied to the adhesive using any known flocking technique suitable for the fibers 22 and adhesive selected. In an exemplary embodiment, the fiber density is between about 200 and 300 grams per square yard, and the fiber length is between about 2.0 mm and 3.0 mm.

A decorative design may be formed on the flocking layer 20, to enhance the aesthetic quality of the surface covering. In an exemplary embodiment, the design may be formed by a screen printing process, wherein ink is applied to the surface of the fibers 22 in the flocking layer at locations corresponding to the desired design.

In an alternate embodiment, a dye sublimation process is used to apply the decorative design, wherein the dye is printed onto a transfer medium, then the transfer medium is placed against the surface of the flocking layer 20 and heat is applied. The heat converts the dye to a gaseous state and opens pores in the fibers 22 allowing the ink to penetrate the surface of the fibers 22. The dye sublimation process provides a design that is more durable than a design printed onto the surface of the fibers 22.

To facilitate handling and installation, the surface covering 1 may be provided in tiles or continuous sheets. Moreover, the continuous sheets may be rolled. In the case of rolled continuous sheets, the surface covering 1 may be transported to the installation site in the rolled form. The surface covering 1 can then be unrolled and applied to the desired surface at the installation site. Depending upon the size of the surface to be covered, multiple continuous sheets of the surface covering 1 may need to be applied adjacent one another, aligning the pattern as required. The surface covering 1 may be applied by taping it with double faced carpet tape or by gluing it with releasable or other forms of carpet adhesive.

While the surface covering 1 is well suited to use on residential and/or office floors to provide impact sound absorption, the surface covering 1 of the present invention is relatively thin and inexpensive, while providing good sound properties, and therefore may also be utilized in vehicles as interior trim or even as a wall covering.

An advantage of the present invention is that the surface covering 1 can be recycled, and accordingly, the surface covering can comprise recycled material, including recycled surface covering.

Next, a method for making a surface covering according to an exemplary embodiment of the invention will be described.

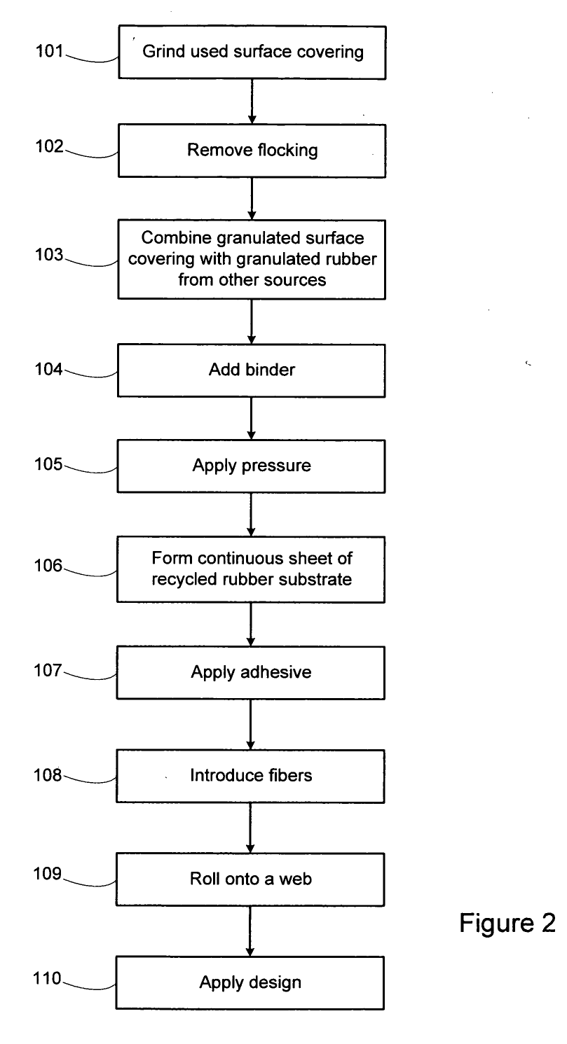

As shown in FIG. 2, when the surface covering becomes worn or soiled, it can be removed and ground to form granulated recycled surface covering 14 (step 101). The surface covering may, for example, be ground using grinding equipment available for grinding tires for recycling. In an exemplary embodiment, at least some of the flocking is removed using a vacuum system (step 102), which may be a dust collection system that is used to remove tire cord when tires are ground for recycling.

The granulated surface covering may be combined with granulated rubber from other sources (step 103). The granulated rubber from other sources may be recycled granulated rubber, such as from tires, or may be virgin granulated rubber, or a combination of the two. The granulated rubber mixture is combined with a binder 18 (step 104) and pressure is applied (step 105) to set or cure the granulated rubber and binder mixture. The binder 18 is preferably polyurethane foam. The container may be a cylindrical container, thereby forming a cylindrical recycled rubber billet comprising granulated recycled rubber and binder.

Next, a continuous sheet of recycled rubber substrate 10 is formed (step 106) by rotating the cylindrical recycled rubber billet and introducing a blade at the outside surface of the billet. The blade is biased into the billet to shave off a continuous layer of the billet.

An adhesive is applied to the continuous sheet of recycled rubber substrate 10 (step 107). The adhesive, as previously described may be one of a variety of polymeric adhesives, with an acrylic adhesive being particularly suited for use in the invention. The adhesive is applied to the front or face surface of the substrate 10, only.

Next, fibers 22 are introduced onto the adhesive using any known flocking process, including but not limited to electrostatic flocking to form a continuous sheet of surface covering (step 108). The continuous sheet of surface covering may optionally be rolled onto a web to form a roll of surface covering (step 109).

A design may optionally be applied to the fibers 22 of the surface covering to provide an aesthetic appearance (step 110). The design may be applied using a screen printing technique, or alternatively may be applied using a dye sublimation process, wherein dye is first printed onto a transfer sheet, then the transfer sheet is disposed against the fibers 22 and heat is applied.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A surface covering, comprising:
a substrate formed at least partially from granulated recycled rubber and a binding agent; and
a flocking layer adhered to the substrate with an adhesive.

2. The surface covering of claim 1, wherein the binding agent is urethane.

3. The surface covering of claim 1, wherein the adhesive is an acrylic adhesive

4. The surface covering of claim 1, wherein the substrate is shaved from a cylindrical billet of granulated recycled rubber.

5. The surface covering of claim 1, wherein the substrate comprises granulated recycled rubber from recycled surface covering.

6. The surface covering of claim 5, wherein the substrate further comprises granulated recycled rubber from other sources.

7. The surface covering of claim 5, wherein the substrate comprises at least 10 wt-% of reground rubber from recycled surface covering.

8. The surface covering of claim 1, wherein a decorative design is formed on the flocking layer.

9. The surface covering of claim 8, wherein the decorative design is formed using a dye sublimation process.

10. A method for recycling a surface covering comprising flocking adhered to a granulated recycled rubber substrate, comprising the steps of:
grinding used surface covering to form granulated recycled rubber;
mixing the granulated recycled rubber with a binder;
compressing the mixture of ground rubber and binder to form a billet;
shaving a continuous substrate off of the billet; and
flocking the substrate.

11. The method of claim 10, wherein the binder is polyurethane.

12. The method of claim 10, wherein the step of flocking the substrate includes applying adhesive to the substrate and introducing fibers to the adhesive.

13. The method of claim 10, wherein the method further comprises, prior to the step of mixing the granulated recycled rubber, the step of:
removing flocking material from the granulated recycled rubber.

14. The method of claim 13, wherein the flocking material is removed using a vacuum.
